(19) United States
(12) Patent Application Publication
(10) Pub. No.: US 2009/0306891 A1
(43) Pub. Date: Dec. 10, 2009

(54) NAVIGATION DEVICE AND METHOD OF CONTROLLING THE SAME

(76) Inventors: Myounghoon JEON, Pyeongtaek-si (KR); Ubeom Heo, Pyeongtaek-si (KR); Junho Park, Pyeongtaek-si (KR); Jaemin Lee, Pyeongtaek-si (KR); Jeonghee Ahn, Pyeongtaek-si (KR); Kwangsoo Choi, Pyeongtaek-si (KR)

Correspondence Address: BIRCH STEWART KOLASCH & BIRCH, PO BOX 747, FALLS CHURCH, VA, 22040-0747, US

(21) Appl. No.: 12/466,620

(22) Filed: May 15, 2009

(30) Foreign Application Priority Data
Jun. 10, 2008 (KR) 10-2008-0054071

(51) Int. Cl. G01C 21/36

(52) U.S. Cl. 701/209

(57) ABSTRACT

A navigation device including a display configured to display map information indicating a traveling route of a vehicle including the navigation device, a memory configured to store a plurality of sound source files for providing aural information adapted to represent directional changes to be made by the vehicle in accordance with the displayed map information, and a controller configured to check the map information and determine a directional change the vehicle is to make in the traveling route of the vehicle, to search the memory for a sound source file corresponding to the determined directional change the vehicle is to make, and to output the sound source file at a preset time before the directional change is to be made to inform a driver of the vehicle about what directional change is upcoming.

This non-provisional application claims priority under 35 U.S.C. § 119(a) to Patent Application No. 10-2008-0054071 filed in Republic of Korea on Jun. 10, 2008, the entire contents of which are hereby incorporated by reference.

### BACKGROUND OF THE INVENTION

1. Field of the Invention

The present application relates to a navigation device and a method of controlling the same.

2. Description of the Related Art

A navigation device for a vehicle such as a telematics terminal provides a navigation function. The navigation function is an application for navigating a route from a starting point or a current position of a vehicle to a desired destination, matching the route to map data, and then displaying the matched data to thus showing a driver the vehicle's travel route.

The navigation device also shows a driver a vehicle's travel by displaying map data on a display and providing visual information. However, the displayed visual information may disturb a driver's sight and hinder concentration of sight for safety driving a vehicle.

### SUMMARY OF THE INVENTION

Accordingly, an object of the present invention is to address the above-noted and other problems.

Another object of the present invention is to provide a novel navigation apparatus and corresponding method for providing sound information to assist a driver in driving their vehicle.

To achieve these and other advantages and in accordance with the purpose of the present invention, as embodied and broadly described herein, the present invention provides in one aspect a navigation device including a display configured to display map information indicating a traveling route of a vehicle including the navigation device, a memory configured to store a plurality of sound source files for providing aural information adapted to represent directional changes to be made by the vehicle in accordance with the displayed map information, and a controller configured to check the map information and determine a directional change the vehicle is to make in the traveling route of the vehicle, to search the memory for a sound source file corresponding to the determined directional change the vehicle is to make, and to output the sound source file at a preset time before the directional change is to be made to inform a driver of the vehicle about what directional change is upcoming.

In another aspect, the present invention provides a method of controlling a navigation device, and which includes displaying map information indicating a traveling route of a vehicle including the navigation device, storing, in a memory, a plurality of sound source files for providing aural information adapted to represent directional changes to be made by the vehicle in accordance with the displayed map information, checking the map information and determine a directional change the vehicle is to make in the traveling route of the vehicle, searching the memory for a sound source file corresponding to the determined directional change the vehicle is to make, and outputting the sound source file at a preset time before the directional change is to be made to inform a driver of the vehicle about what directional change is upcoming.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a block diagram illustrating a navigation device according to an embodiment of the present invention;

FIG. 2 is a flowchart illustrating a method of controlling a navigation device according to an embodiment of the present invention;

FIGS. 3A and 3B are graphs illustrating examples of sound source files for performing the method of controlling a navigation device according to an embodiment of the present invention;

FIGS. 4A and 4B are graphs illustrating another example of sound source files for performing the method of controlling a navigation device according to an embodiment of the present invention;

FIGS. 5A and 5B are graphs illustrating still another example of sound source files for performing the method of controlling a navigation device according to an embodiment of the present invention; and

FIGS. 6A to 6D are graphs illustrating yet another example of sound source files for performing the method of controlling a navigation device according to an embodiment of the present invention.

### DETAILED DESCRIPTION OF THE INVENTION

Reference will now be made in detail to the preferred embodiments of the present invention, examples of which are illustrated in the accompanying drawings.

FIG. 1 is a block diagram illustrating an example of a navigation device 100 according to an embodiment of the present invention. In addition, the navigation device 100 corresponds to a variety of portable terminals, which can perform a navigation function while operating in conjunction with a global positioning system (GPS) receiver that receives navigation messages from GPS satellites within a vehicle.

As shown in FIG. 1, the navigation device 100 includes a GPS receiver 110, a map data storage 120, an input 130, a controller 140, memory 150, a signal processor 160, a display 170, a sound output module 180, and speakers 190-1 and 190-2. Further, the GPS receiver 110 receives navigation messages including position information transmitted from GPS satellites through a GPS antenna connected thereto. Accordingly, the navigation device 100 can provide various pieces of information for controlling the travel of a vehicle in which the navigation device is mounted based on navigation messages. Also, although the present description refers to the GPS receiver 110 being mounted in the navigation device, the GPS receiver 110 may be mounted in a vehicle as a separate device and implemented to perform a navigation function while operating in conjunction with the navigation device 100.

In addition, the map data storage 120 stores a variety of map data including text data and image data used to perform a navigation function. Although the present description describes the map data storage 120 as a component separate from the memory 150, the map data may be stored in the memory 150. Further, the input 130 receives information from a user including a variety of control commands for selecting and operating various functions that are provided by the navigation device 100 such as a navigation function and a multimedia play function. The input 130 may be implemented using at least one of a key input including one or more numeric keys or function keys, a touch pad where information can be entered by a user's touch, and a remote controller that can be installed in a steering wheel, etc. of a vehicle for manipulating convenience of the information processing unit 100 for the vehicle.

Also, the controller 140 controls an overall operation of the navigation device 100. In particular, when a navigation function is selected, the controller 140 searches the map data storage 120 for map data including a variety of positions such as a current position, a starting point, and a destination of a vehicle based on navigation messages received by the GPS receiver 110, controls the signal processor 160 to process the map data into video signals and audio signals for the vehicle's driving guidance, and controls the display 170 and the sound output module 180 to output the processed signals.

In addition, the controller 140 checks a situation or a point of time where a vehicle's turn is required while the vehicle is driven according to the vehicle's travel route according to a navigation function of the navigation device 100, searches sound source files stored in the memory 150 to guide the vehicle's turn accordingly, controls the signal processor 160 to process the sound source files into audio signals, and controls the sound output module 180 to output the processed sound source files.

Further, the memory 150 may include nonvolatile memory for storing programs, data, etc., which are used to perform various functions provided from the navigation device 100, and nonvolatile memory for temporarily storing a variety of data occurring according to an operation of the navigation device 100. Also, to show a driver a vehicle's turns through an aural signal, the nonvolatile memory of the memory 150 may store a variety of sound source files, which are prepared to provide sound through which directional perception, distance perception and spatial impression can be intuitively transferred to the driver so that the sound source files correspond to the types of vehicle's turns.

In addition, the signal processor 160 processes map data, which is searched and output from the map data storage 120 according to a navigation message received from the GPS receiver 110, into a format that can be displayed on the display 170, and displays the processed map data on the display 170. The signal processor 160 also processes audio signals and outputs the processing results to the sound output module 180. Further, the signal processor 160 decodes audio signals from sound source files input from the memory 150, performs a signal process on the decoded audio signals, and outputs the processing result to the sound output module 180.

The display 170 may be implemented using a display device such as a liquid crystal display (LCD) and displays video signals input from the signal processor 160. Alternatively, the display 170 may be implemented using a touch screen, and may be implemented to display not only a display function, but also various functions provided by the navigation device 100 in a menu structure and at the same time perform an input function of executing a menu selected by a user's touch using a finger, a stylus pen, and so on.

Further, the sound output module 180 amplifies audio signals input from the signal processor 160 to a specific level selected through the input 130 and outputs the amplified audio signal through two or more speakers. The sound output module 180 also processes audio signals, which are induced and input by the signal processor 160 from a sound source file that is searched from the memory 150, to output sound that provides directional perception, distance perception and spatial impression for guiding a user in a vehicle's turn through a plurality of channels of audio signals. Accordingly, the sound output module 180 may amplify the plurality of separated channel signals individually and output the amplified channel signals to the speakers 190-1 and 190-2, each corresponding to the channel signals. Also, the navigation device 100 in FIG. 1 includes the two speakers 190-1 and 190-2, but the navigation device 100 may include, for example, four or more speakers.

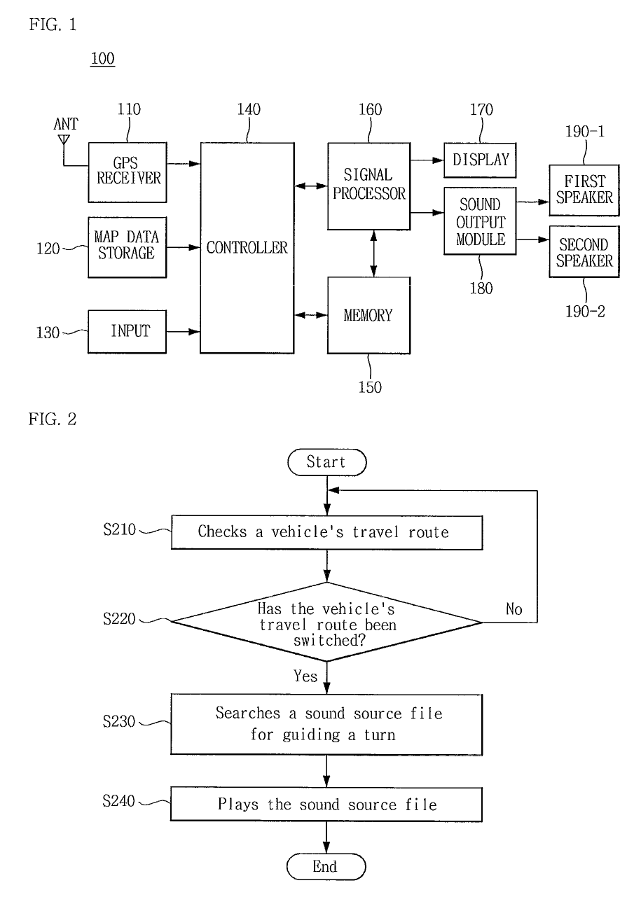

Next, FIG. 2 is a flowchart illustrating an example of a method of controlling a navigation device according to an embodiment of the present invention. As shown in FIG. 2, while a vehicle is moved according to a set route using a navigation function of the navigation device 100, the navigation device 100 checks the vehicle's travel route (S210) to determine whether the vehicie's turn is required with respect to the vehicle's current travel direction in the set route (S220). If, as a result of the determination, the vehicle's turn is required on the set route (Yes in S220), the controller 140 searches the memory 150 for a sound source file for guiding a turn that is previously stored in response to the corresponding turn (S230) and controls the sound source file to be applied to the signal processor 160.

The signal processor 160 also generates audio signals by decoding the sound source file according to its format and inputs the generated audio signals to the sound output module 180. The sound output module 180 then separates the audio signals into a plurality of channel signals, amplifies the separated channel signals individually, and outputs the amplified signals to the speakers 190-1 and 190-2 (S240).

Further, according to one embodiment of the present invention, a sound source file corresponding to each turn may be generated by multiplexing a plurality of channel audio signals that are respectively formed adequately using a variety of specific sound effects for modifying or modulating acoustic waves in order to represent a shift in the volume level of each channel audio signal as the time goes and changes of where sound is originated, i.e., by controlling a directional perception, distance perception and/or spatial impression.

That is, an available sound effect may include, for example, a method of adjusting the waveform of an acoustic wave through reverberation (i.e., an echo effect of sound in the space), delay (i.e., a mechanical sound delay effect), equalization (i.e., control of a frequency such as intensity of high and low frequency of acoustic waves), and so on. Alternatively, a variety of other sound effects may be used.

In addition, if a sound source of a sound source file to which this sound effect has been applied is separated into respective channel signals and played through speakers respectively corresponding to channels, a driver can aurally recognize a request for a vehicle's turn through an effect in which a direction where sound is heard is changed, an effect in which sound becomes gradually far or close, an effect in which sound rings and is heard far away, or a change in a directional perception and a distance perception which is a sensory perception of distance where sound is originated and spatial impression which is a sensory perception of space made by sound such as that sound is clear and looks heard nearby.

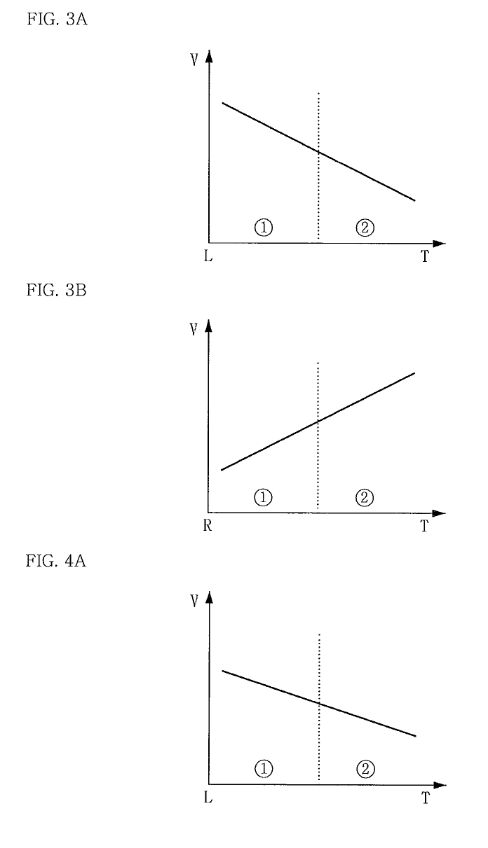

Next, FIGS. 3A and 3B are graphs showing examples of sound source files for guiding a right turn according to an embodiment of the present invention. In more detail, FIG. 3A shows a shift in the volume (V) according to the lapse of time (T) of sound output from a left speaker, for example, the first speaker 190-1, and FIG. 3B shows a shift in the volume (V) according to the lapse of time (T) of sound output from a right speaker, for example, the second speaker 190-2.

As shown in FIGS. 3A and 3B, the left speaker 190-1 outputs sound of a high level in a first time section \textcircled{1} and, as time goes by, outputs sound of a low level in a second time section \textcircled{2}, and the right speaker 190-2 outputs sound of a low level in a first time section \textcircled{1} and, as time goes by, outputs sound of a high level in a second time section \textcircled{2}. Accordingly, if this sound source file is played when a right turn is required, a driver can be made to aurally recognize a change in a spatial impression of sound, such as that sound is moving from the left side to the right side. Thus, the driver can intuitively understand that a turn to the right is required according to an aural stimulus without a series of processes for recognizing the meaning of language information such as the left turn or the right turn, so that a driver can manipulate the vehicle to make an appropriate turn more easily and accurately.

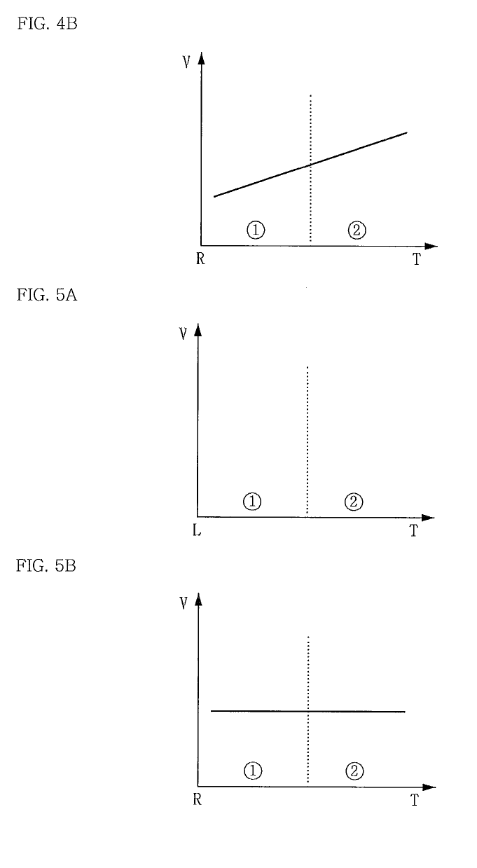

Next, FIGS. 4A and 4B are graphs showing another example of sound source files for guiding a right turn, and FIGS. 5A and 5B are graphs showing still another example of sound source files for guiding a right turn. In more detail, FIGS. 4A and 4B show examples in which sound source files have a relatively small level shift according to time as compared with the sound source files shown in FIGS. 3A and 3B, and FIGS. 5A and 5B show examples in which sound of the left speaker 190-1 is very low or silent and sound of the right speaker 190-2 has a specific level or more. Although FIG. 5B shows that there is no level shift of sound, the level of sound may change such as an increase in sound.

Also, any one of the examples of the sound source files may be used individually to perform a vehicle's moving guidance, and also may be used in combination. For example, in controlling the navigation device 100, the sound source files as shown in FIGS. 4A and 4B may be played, for example, 500 meters ahead of a point where a right turn is generated according to a set route, the sound source files as shown in FIGS. 3A and 3B may be played, for example, 250 meters ahead according to the set route, and the sound source files as shown in FIGS. 5A and 5B may be played near the point where the right turn is generated according to the set route.

In other words, the intensity of a spatial impression for guiding a right turn, that is, a difference in the level of left and right sounds is changed according to a distance up to an actual right turn point. Accordingly, accuracy in route guidance and vehicle manipulation accordingly can be increased. Also, a vehicle's right turn has been described above as an example. However, when turns such as a left turn or a U-turn are necessary, a directional perception can be transferred through sound by applying a sound effect or controlling characteristics such as the level of sound with respect to each channel signal of a sound source file so that a directional perception or a distance perception can be changed according to time.

Also, for a right turn that is different than the examples described with reference to FIGS. 3A to 5B, a sound source file can be formed by changing the right and left sides of the channel signals output to the left speaker 190-1 and the right speaker 190-2. As another example, for a U-turn, a sound source file can be formed by first applying an effect in which sound is heard at a distant place of a right side direction and then an effect in which the sound is moved to a close distance of the right side direction, and thereafter applying an effect in which the sound is generated at a close distance of a left side direction and then controlling the sound effect in such a manner that the sound is generated at a distant place of the left side direction.

That is, a sound effect is generated in such a manner that both a directional perception and a distance perception of sound are changed accordingly. Therefore, the change generated in the directional perception and the distance perception of sound responses to the change in an actual moving direction of a vehicle, which is necessary for a U-turn, so acoustic information of a turn such as a U-turn can be immediately provided to a driver.

Further, when a vehicle is driven up or down a slope in addition to typical turns such as a left turn, a right turn or a U-turn, a sound source file in which a direction where sound is heard has changed to an upward direction or a downward direction by adapting the above specific sound effects can be generated and used. Accordingly, when a vehicle is driven up or down a slope while making a left turn and a right turn, if the above embodiments are applied while applying an additional specific sound effect a sound source file to which a sound effect in which, for example, when the vehicle has to be driven up a slope having a right turn, a direction where sound is heard changes from a downward direction to an upward direction while the direction changes to the right side has been applied can be generated and used.

Alternatively, there can be provided aural information indicating that a vehicle's moving direction has to be changed to a corresponding direction to change a directional perception of sound to not only a left turn and a right turn, but also a certain direction having an angle of 360 degrees based on the vehicle by applying respective sound effects to respective channel audio signals.

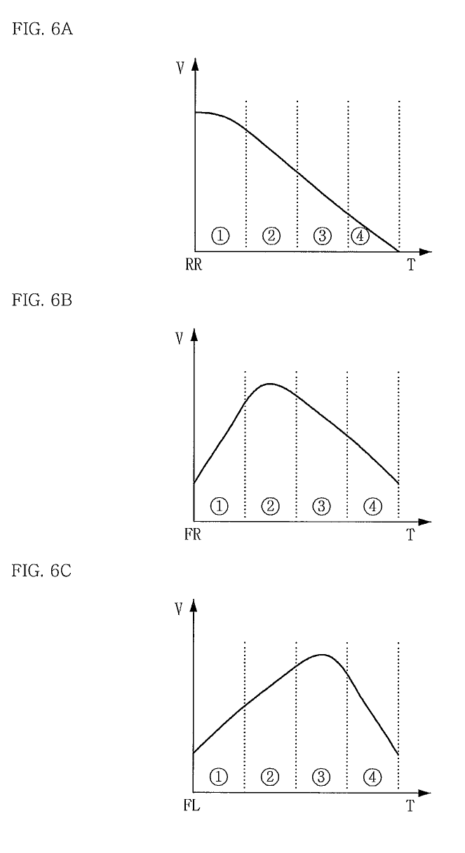

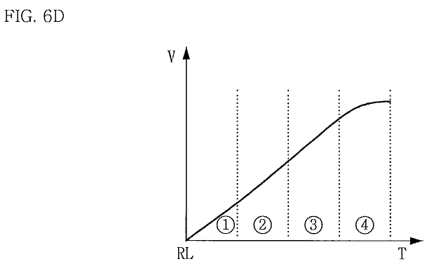

Next, FIGS. 6A to 6D are graphs showing yet another example of sound source files for guiding a U-turn of turns of a vehicle according to an embodiment of the present invention. In this example, a sound source file is separated into four channel signals, and respective channel signals are output to four speakers RR, FR, FL, and RL of a rearward right side, a forward right side, a forward left side, and a rearward left side, respectively.

Referring to FIGS. 6A to 6D, and assuming that time is divided into four sections, the volume of sound of the four channel signals is the highest on the rearward right side RR in a first section \textcircled{1}, on the forward right side FR in a next section \textcircled{2}, on the forward left side FL in a third section \textcircled{3}, and on the rearward left side RL in the last section \textcircled{4}. Consequently, when a sound source file is played through four speakers, an aural effect in which sound is moved from the rearward right side to the forward and then moved to the rearward left side can be generated. Accordingly, the same aural information as that of a turn according to a U-turn can be provided.

Also, in the above embodiments, a method of providing aural information indicating a spatial impression or a directional/distance perception using sound effects has been described. However, indicators for guiding the right side, the left side or other turn may also be displayed on the display 170 of the navigation device 100 or visual guidance may be provided through flickering or color change to the display 170. Accordingly, a driver may be further helped to recognize a vehicle's turn and perform an appropriate operation.

Further, the controller 180 can also determine if an audio source is currently being played in the vehicle, and control a volume of the left and right speakers to indicate the directional change is a right-turn, a left-turn or a U-turn. That is, the driver of the vehicle may be currently listening to music on a radio station, via an MP3 Player or other audio played installed in the vehicle, and control the volume of the music according to the above-embodiments to indicate a left-turn, right-turn or U-turn rather than playing a separate sound source.

In addition, if the navigation system is activated and the driver is listening to music at the same time, the controller 180 can automatically turn the volume down or turn off the volume of one of the sound sources (e.g., the music playing or the sound source of the navigation system) and output the other of the sounds sources. For example, the controller 180 can turn down or turn off the music being played and output the selected sound source file for the navigation system so the driver can accurately hear the sound source file. Alternatively, the controller 180 can not output the sound source file for the navigation system and instead adjust the volume of the music being played to inform the user of the directional change.

Thus, the present invention provides several advantages. That is, aural information indicating a specific direction/distance or a change thereof by applying sound effect to represent a spatial impression or a directional/distance perception is provided to a user to guide a vehicle's turns.

Further, because sound source files are used instead of spoken language information, it is easier for the driver to recognize what turn is being requested. That is, the driver of the vehicle immediately and intuitively recognizes what turn is being requested, instead of first having to understand the meaning of a spoken language. Also, many users drive when visiting countries where their language is not spoken. For example, a Korean speaking person who is driving in the USA may not easily recognize English driving instructions being output on a navigation terminal installed in a rental car, for example. However, according to embodiments of the present invention, the Korean speaking person can easily recognize driving instructions because sound source files are used (rather than spoken English language).

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A navigation device, comprising:
a display configured to display map information indicating a traveling route of a vehicle including the navigation device;
a memory configured to store a plurality of sound source files for providing aural information adapted to represent directional changes to be made by the vehicle in accordance with the displayed map information; and
a controller configured to check the map information and determine a directional change the vehicle is to make in the traveling route of the vehicle, to search the memory for a sound source file corresponding to the determined directional change the vehicle is to make, and to output the sound source file at a preset time before the directional change is to be made to inform a driver of the vehicle about what directional change is upcoming.

2. The navigation device of claim 1, wherein the controller is further configured to output the sound source file via at least two speakers including left and right speakers included in the vehicle.

3. The navigation device of claim 2, wherein the controller is further configured to output the sound source file with a first volume on the left speaker and a second volume on the right speaker in which the first volume is higher than the second volume, and to gradually decrease the first volume on the left speaker and gradually increase the second volume on the right speaker so as to indicate to the driver the directional change is a right turn.

4. The navigation device of claim 2, wherein the controller is further configured to output the sound source file with a first volume on the left speaker and a second volume on the right speaker in which the first volume is lower than the second volume, and to gradually increase the first volume on the left speaker and gradually decrease the second volume on the right speaker so as to indicate to the driver the directional change is a left turn.

5. The navigation device of claim 2, wherein the controller is further configured to output the sound source file with a first volume on the left speaker and a second volume on the right speaker in which the first volume is lower than the second volume so as to indicate to the driver the directional change is a right turn.

6. The navigation device of claim 2, wherein the controller is further configured to output the sound source file with a first volume on the left speaker and a second volume on the right speaker in which the first volume is higher than the second volume so as to indicate to the driver the directional change is a left turn.

7. The navigation device of claim 2, wherein the at least two speakers include four speakers including a front left speaker, a front right speaker, a rear left speaker and a rear right speaker, and
wherein the controller is further configured to output the sound source file in a circular manner around the rear right speaker, the front right speaker, the front left speaker, and the rear left speaker to indicate to the driver the directional change is a U-turn.

8. The navigation device of claim 7, wherein the controller is further configured to output the sound source file at the rear right speaker with a higher volume compared to volumes for the front right speaker, the front left speaker, and the rear left speaker during a first time period, to output the sound source file at the front right speaker with a higher volume compared to volumes for the rear right speaker, the front left speaker, and the rear left speaker during a second time period, to output the sound source file at the front left speaker with a higher volume compared to volumes for the rear right speaker, the front right speaker, and the rear left speaker during a third time period, and to output the sound source file at the rear left speaker with a higher volume compared to volumes for the rear right speaker, the front right speaker, and the front left speaker during a fourth time period.

9. The navigation device of claim 2, wherein the controller is further configured to determine if an audio source is currently being played in the vehicle, and to control a volume of the left and right speakers to indicate the directional change is a right-turn, a left-turn or a U-turn.

10. The navigation device of claim 1, wherein the controller is further configured to generate a sound effect of the output sound source file by controlling at least one of a directional perception, a distance perception and a spatial impression of the output sound so as to indicate to the driver the directional change that is to be made.

11. A method of controlling a navigation device, the method comprising:
displaying map information indicating a traveling route of a vehicle including the navigation device;
storing, in a memory, a plurality of sound source files for providing aural information adapted to represent directional changes to be made by the vehicle in accordance with the displayed map information;
checking the map information and determine a directional change the vehicle is to make in the traveling route of the vehicle;
searching the memory for a sound source file corresponding to the determined directional change the vehicle is to make; and
outputting the sound source file at a preset time before the directional change is to be made to inform a driver of the vehicle about what directional change is upcoming.

12. The method of claim 11, wherein the outputting step outputs the sound source file via at least two speakers including left and right speakers included in the vehicle.

13. The method of claim 12, wherein the outputting step outputs the sound source file with a first volume on the left speaker and a second volume on the right speaker in which the first volume is higher than the second volume, and gradually decreases the first volume on the left speaker and gradually increases the second volume on the right speaker so as to indicate to the driver the directional change is a right turn.

14. The method of claim 12, wherein the outputting step outputs the sound source file with a first volume on the left speaker and a second volume on the right speaker in which the first volume is lower than the second volume, and gradually increases the first volume on the left speaker and gradually decreases the second volume on the right speaker so as to indicate to the driver the directional change is a left turn.

15. The method of claim 12, wherein the outputting step outputs the sound source file with a first volume on the left speaker and a second volume on the right speaker in which the first volume is lower than the second volume so as to indicate to the driver the directional change is a right turn.

16. The method of claim 12, wherein the outputting step outputs the sound source file with a first volume on the left speaker and a second volume on the right speaker in which the first volume is higher than the second volume so as to indicate to the driver the directional change is a left turn.

17. The method of claim 12, wherein the at least two speakers include four speakers including a front left speaker, a front right speaker, a rear left speaker and a rear right speaker, and
wherein the outputting step outputs the sound source file in a circular manner around the rear right speaker, the front right speaker, the front left speaker, and the rear left speaker to indicate to the driver the directional change is a U-turn.

18. The method of claim 17, wherein the outputting step outputs the sound source file at the rear right speaker with a higher volume compared to volumes for the front right speaker, the front left speaker, and the rear left speaker during a first time period, outputs the sound source file at the front right speaker with a higher volume compared to volumes for the rear right speaker, the front left speaker, and the rear left speaker during a second time period, outputs the sound source file at the front left speaker with a higher volume compared to volumes for the rear right speaker, the front right speaker, and the rear left speaker during a third time period, and outputs the sound source file at the rear left speaker with a higher volume compared to volumes for the rear right speaker, the front right speaker, and the front left speaker during a fourth time period.

19. The method of claim 12, further comprising:
determining if an audio source is currently being played in the vehicle; and
controlling a volume of the left and right speakers to indicate the directional change is a right-turn, a left-turn or a U-turn.

20. The method of claim 11, further comprising:
generating a sound effect of the output sound source file by controlling at least one of a directional perception, a distance perception and a spatial impression of the output sound so as to indicate to the driver the directional change that is to be made.
